(19) United States
(12) Patent Application Publication
(10) Pub. No.: US 2020/0090469 A1
(43) Pub. Date: Mar. 19, 2020

(54) Sports pool betting dividend calculator

(71) Applicant: Sport Pools USA LLC, Delray Beach, FL (US)

(72) Inventors: Mark Aaron Sarembock, Blouberg Rise (ZA); Hilton Lyle Jacobson, Cape Town (ZA)

(21) Appl. No.: 16/527,756

(22) Filed: Jul. 31, 2019

Related U.S. Application Data
(60) Provisional application No. 62/712,347, filed on Jul. 31, 2018.

(51) Int. Cl. G07F 17/32; G06Q 50/34; A63F 13/30

(52) U.S. Cl. CPC G07F 17/3288; G06Q 50/34; G07F 17/3244; G07F 17/3241; G07F 17/3225; A63F 13/30; G07F 17/3223

(57) ABSTRACT

A computer-implemented artificial intelligence, dividend calculator to facilitate bet tracking on line by selecting a pool to bet on from a predefined database, displaying statistical analysis of the selected pool, and employing a dividend calculator wherein a user can enter any plausible combination from the pool to obtain a real-time dividend result.

### PRIORITY APPLICATION

In accordance with 37 C.F.R. § 1.76 a claim of priority is included in an Application Data Sheet filed concurrently herewith. Accordingly, the present invention claims priority to U.S. Provisional Patent Application No. 62/712,347, entitled “SPORTS POOL BETTING DIVIDENT CALCULATOR,” filed Jul. 31, 2018. The contents of the above referenced application is incorporated herein by reference.

### FEDERALLY SPONSORED RESEARCH OR DEVELOPMENT

Not Applicable.

### FIELD OF THE INVENTION

The field of the invention relates generally on-line pool betting and more specifically to a dividend calculator providing potential payouts for any plausible combination of results in real time.

### BACKGROUND OF THE INVENTION

Pool betting is an exciting bet type that has captured the imagination of many sport loving punters. A sports betting pool is similar to a lottery, where participants pay a fixed price per ticket to enter and the funds collected are held pending the outcome of a predefined selection of sports events. The funds collected are shared amongst those who have made the correct predictions, less taxes and profits. Sports pool betting has been steadily growing in popularity, but on-line usage lacks interactive options that would better educate an individual placing a bet as to the capabilities and records of a team and their players. Conventional bet placement generally entails the selection of opponents/teams with little to no information relating to them. This lack of information makes it particularly difficult to make an educated bet on teams that the user potentially knows very little about, and even more difficult to follow once the bet has been placed.

Conventional bet placement also lacks the means to track the progress of a sports pool bet. Conventional bet placement lacks a means that allows an individual to obtain a real time calculation of the potential dividend payout that would be received if the results remain unchanged. These dividend payouts are updated in real-time by the artificial intelligence algorithm, using decision tree analysis and data not available to the users, as scores change. Also lacking in the industry is a means for allowing a user to poll potential payouts based on any selection or potential score change using the same decision tree algorithm.

### SUMMARY OF THE INVENTION

Disclosed is a system to improve the overall experience of the bet life-cycle of a pool-based bet. The system empowers the user to make informed betting decisions, as well as make the tracking of their bets completely transparent and interactive updated in real time using a modern intuitive interface.

An objective of the invention is to provide a dividend calculator that allows a user to select any plausible combination of results and determine the potential payout if the selected results materialize.

Another objective of the invention is to provide a system that allows a user to track their bets in real-time indicating in which fixtures his selections are currently made correct or incorrect.

Another objective of the invention is to provide a system that provides stats, lineups, commentaries and scores about each game in real-time integrated in the users bet, wherein a user of the system can quickly identify which fixtures are currently chosen correctly as well as providing some context around the fixture situation.

Still another objective of the invention is to provide real-time updated payout ticket information relating to the users winning ticket and the current results potentially pay using decision tree analysis of ticket information.

Yet still another objective of the invention is to extend bet types to allow sports pool betting into popular sports like football, basketball and baseball as well as pools that combine different sport types.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a Live Score API system flow diagram;

FIG. 2 is a dividend calculator flow diagram;

FIG. 3 is a screen shot of a product image screen;

FIG. 4 is a screen shot of a bet selection screen;

FIG. 5 is a screen shot of a bet tracking screen;

FIG. 6 is a screen shot of a user bet panel;

FIG. 7 is a screen shot of existing bet placement;

FIG. 8 is a screen shot of what an existing bet looks like once placed;

FIG. 9 is a screen shot of existing bet tracking;

FIG. 10 is a screen shot of existing bet tracking;

FIG. 11 is a screen shot of existing bet tracking;

FIG. 12 is a screen shot of existing bet tracking;

FIG. 13 is a screen shot of the dividend calculator;

FIG. 14 is a screen shot of the dividend calculator;

FIG. 15 is a screen shot of the dividend calculator;

FIG. 16 is a screen shot of the dividend calculator;

FIG. 17 is a screen shot of the dividend calculator;

FIG. 18 shows bet placement in relation to the extended bet types, namely football, basketball and baseball; and

FIG. 19 shows bet tracking for an NFL pool bet.

### DETAILED DESCRIPTION OF THE INVENTION

A detailed embodiment of the instant invention is disclosed herein, however, it is to be understood that the disclosed embodiment is merely exemplary of the invention, which may be embodied in various forms. Therefore, specific functional details disclosed herein are not to be interpreted as limiting, but merely as a basis for the claims and as a representation basis for teaching one skilled in the art to variously employ the present invention in virtually any betting pool.

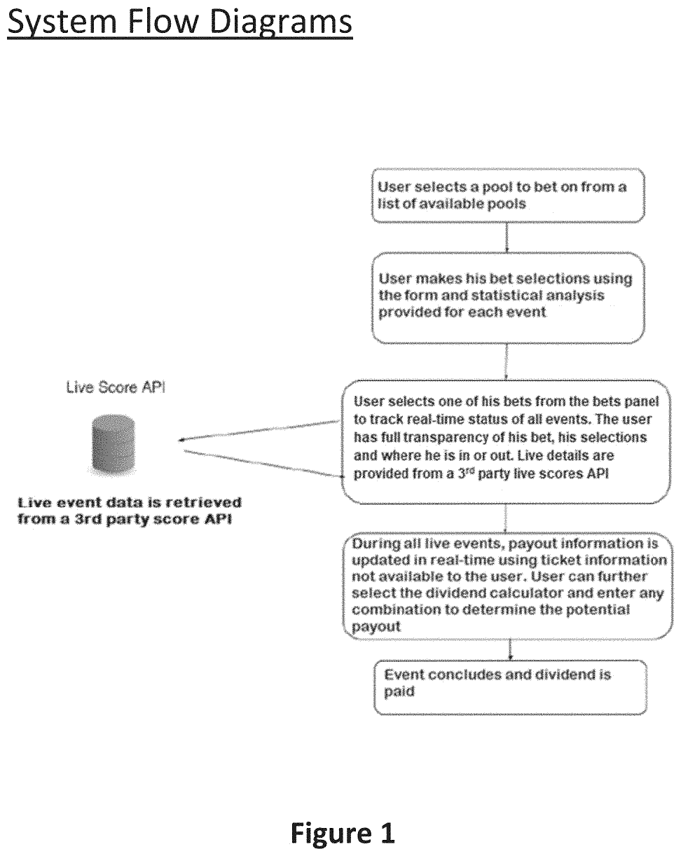

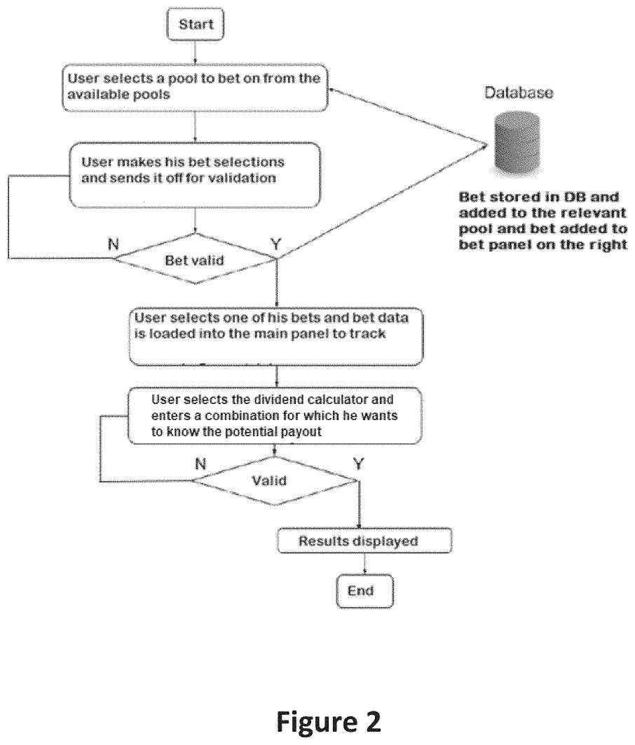

Referring to FIGS. 1 and 2, set forth is a flow diagram for the system which consists of computer-implemented, artificial intelligence using decision tree analysis dividend calculator to facilitate betting by a computer processor on a server that is in network communication with a user terminal. The process consists of selecting a pool to bet on from a predefined database stored on the server by a user terminal. The results of the pool are displayed including a statistical analysis of the selected pool. A user can then place a bet on the selected pool by use of a user terminal wherein the bet is forwarded to a centrally disposed server for validation and placement in a financial pool together with others that have lodged a bet. The bet is validated by use of the server and the bet validation is acknowledged to the user terminal. The user terminal displays information regarding the pool including a dividend calculator wherein the user can enter any plausible combination from the pool to obtain a real-time result of dividend payout, using decision tree analysis. The real-time display of the projected dividend payout is displayed on the user terminal when the pools are closed and the fixtures commence. When the pool is closed, no further tickets may enter the pool. The user can then poll the dividend calculator, to calculate decision tree potential dividends, based on incomplete events. Once the betting on the pool concludes, and the match results are settled, the dividend is paid to the winning tickets. The dividend is calculated as the net pool, that is the pool total less costs, divided by the number of winning tickets.

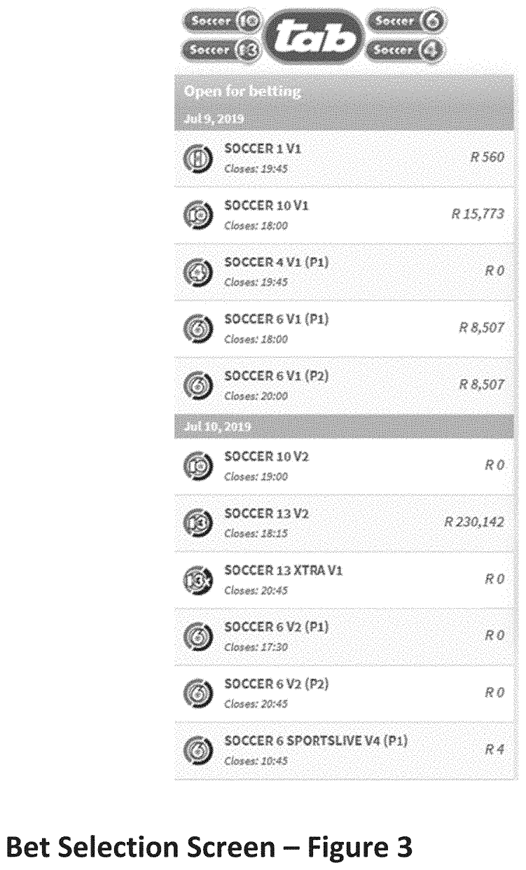

FIG. 3 is a screen shot of a product image screen illustrating various soccer pools that are open for betting. It is noted that only soccer pools are illustrated for ease of clarity. The instant invention can be used with any sports activity including American football, baseball, and so forth. The bet selection displays those pools that are currently receptive to betting including the date and time of the sporting event.

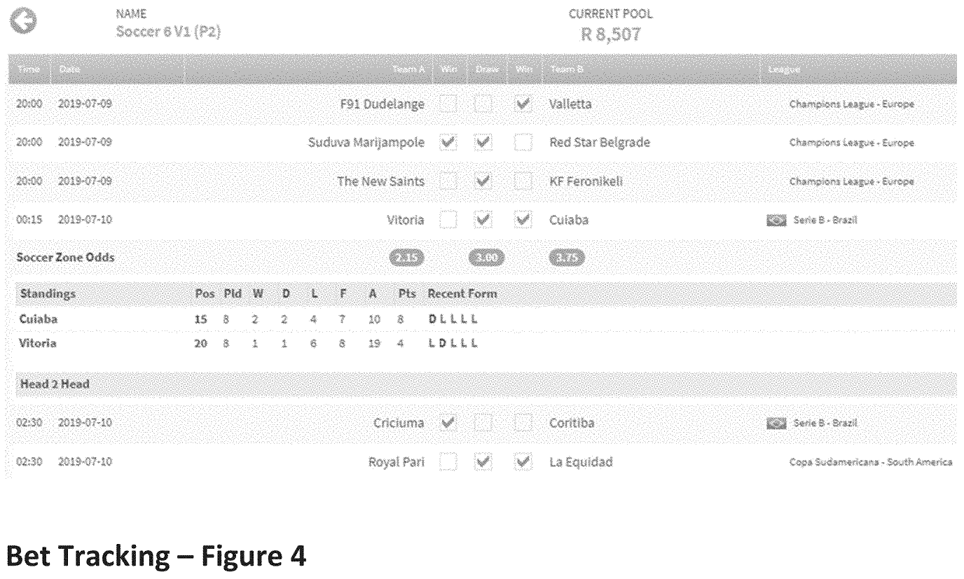

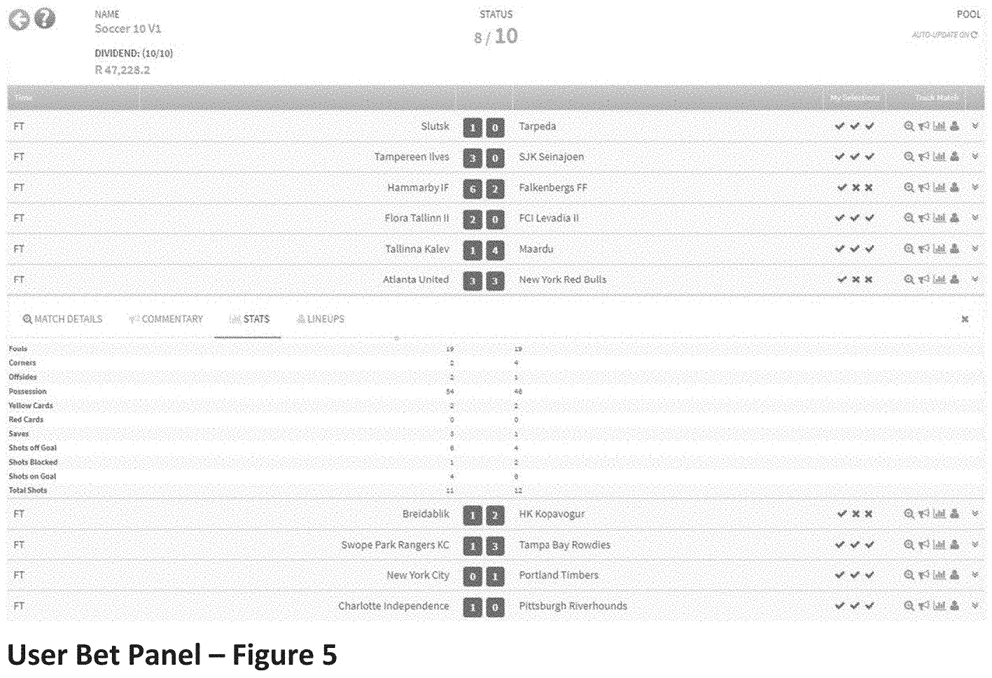

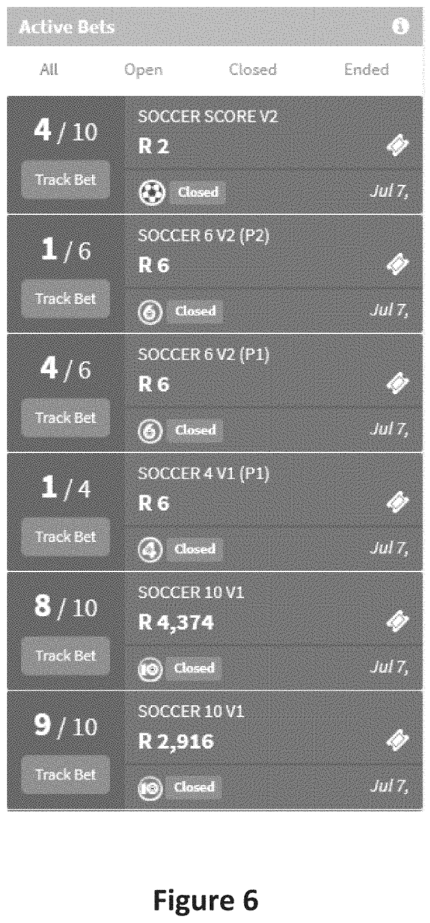

FIG. 4 is a screen shot of a bet selection screen depicting the team of Bahia to win, Cruzeiro to Win, Santos to draw, and Vasco de Gama to win and draw. Beneath the team is a statistical analysis of the team's history including position in the league, winds, draws, loses, points and color-coded listing of the last five games played. FIG. 5 is a screen shot of a bet tracking screen providing the unofficial dividend, the pool, and the statistics of each team as to history regarding fouls, corners, offsides, possession, yellow cards, saves, shots off goal, shots blocked, shots on goal, and total shots. FIG. 6 is a screen shot of an individual user's active bets.

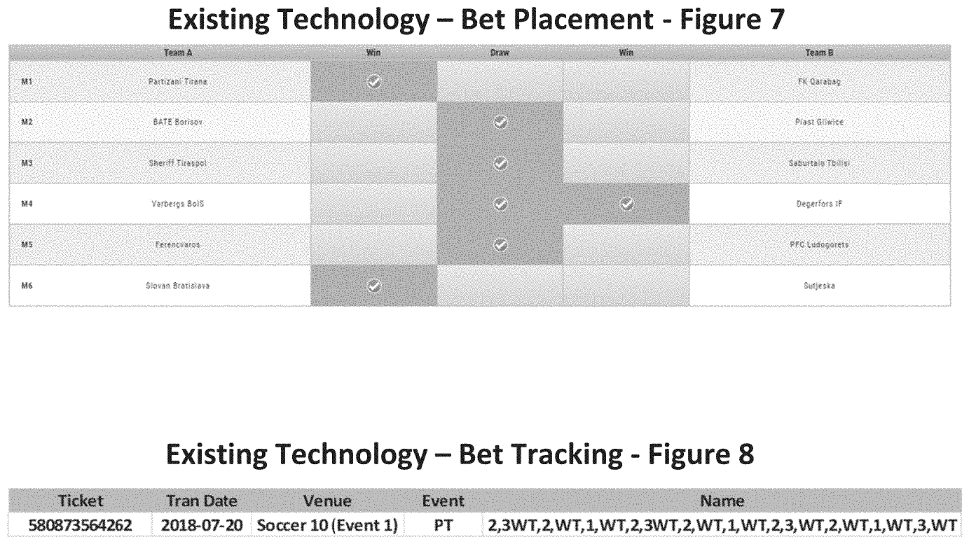

Referring to FIGS. 7 and 8, illustrated is a prior art display of tracking bets which involves decoding a comma separated list of 1, 2 and 3's. This makes it particularly difficult to make an educated bet on teams that a user knows little about, and even more difficult to follow a bet once it's been placed.

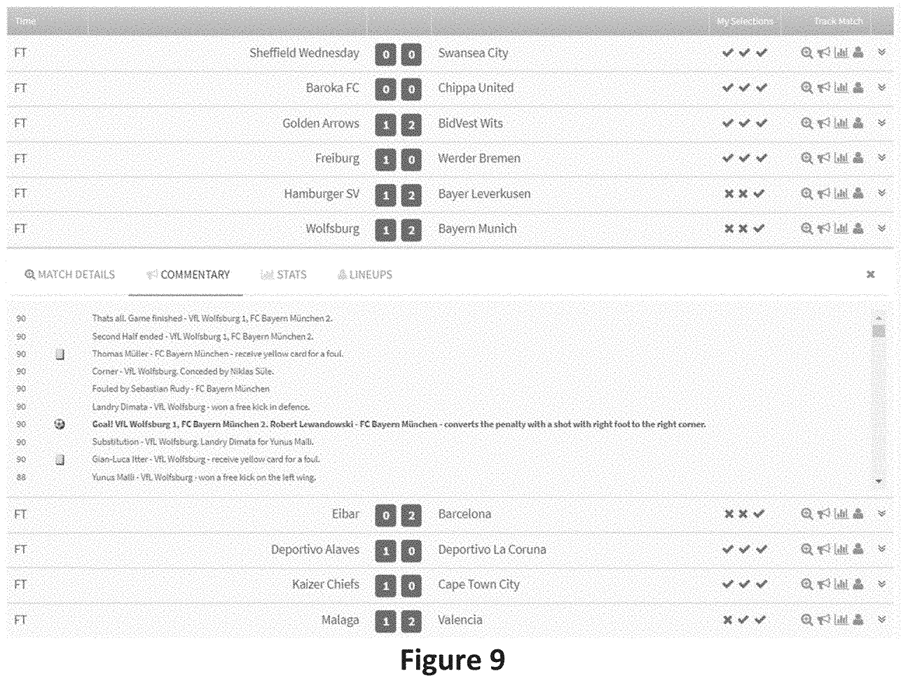

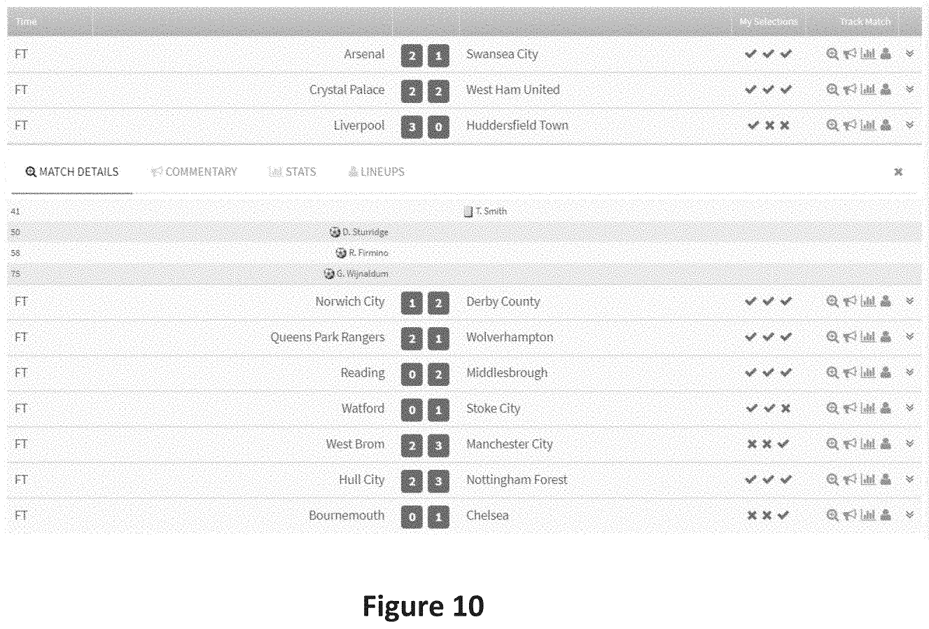

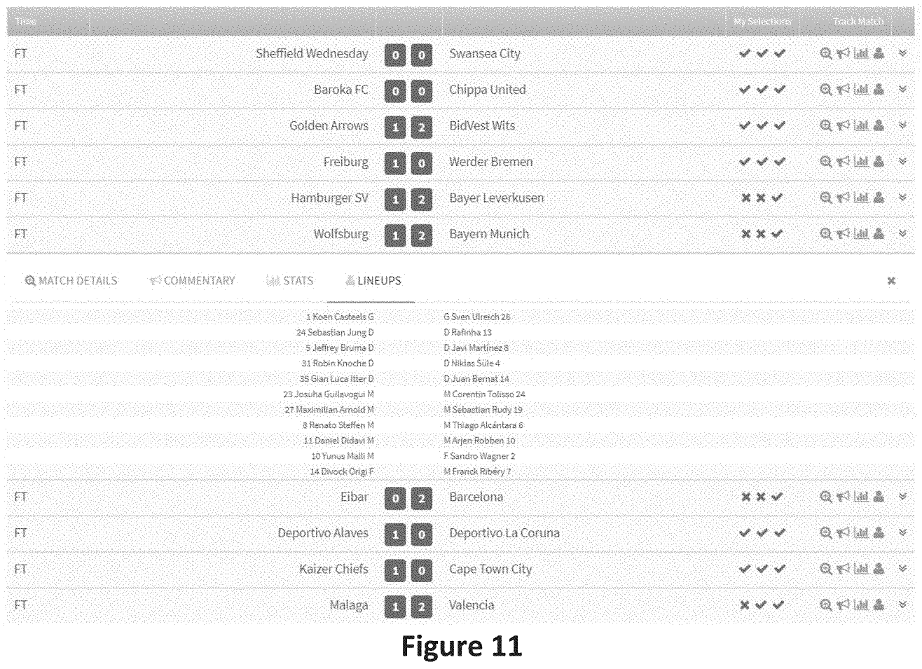

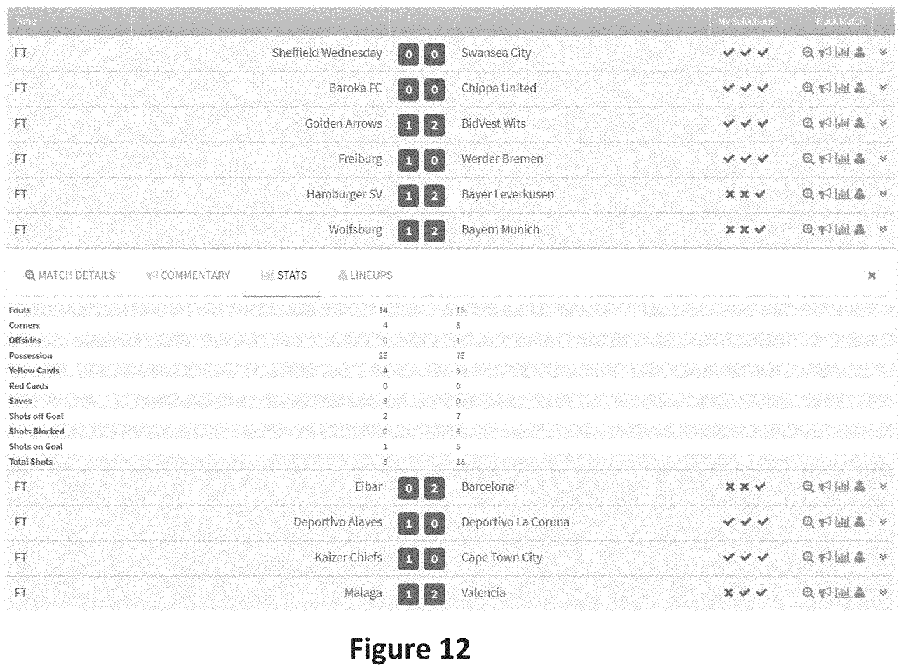

FIG. 9 is a screen shot of a selected pool with match details provided on the selected teams of Wolfsburg and Bayern Munich. FIG. 10 is a screen shot of a selected pool with match details provided on the selected teams of Liverpool and Huddersfield Town. FIG. 11 is a screen shot of a selected pool with lineup details between the teams of Wolfsburg and Bayern Munich. FIG. 12 is a screen shot of a selected pool with statistics regarding the teams of Wolfsburg and Bayern Munich.

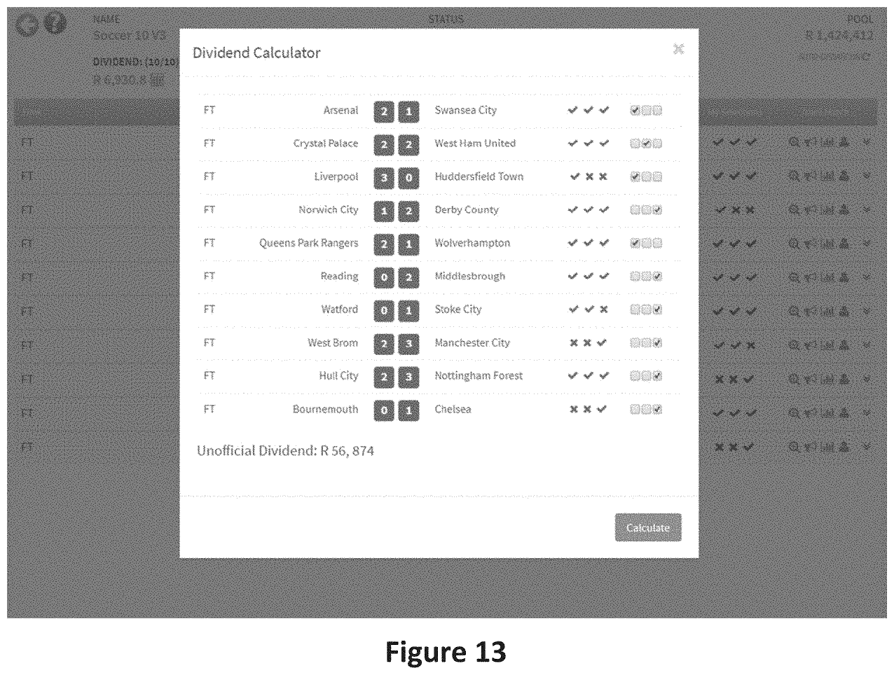

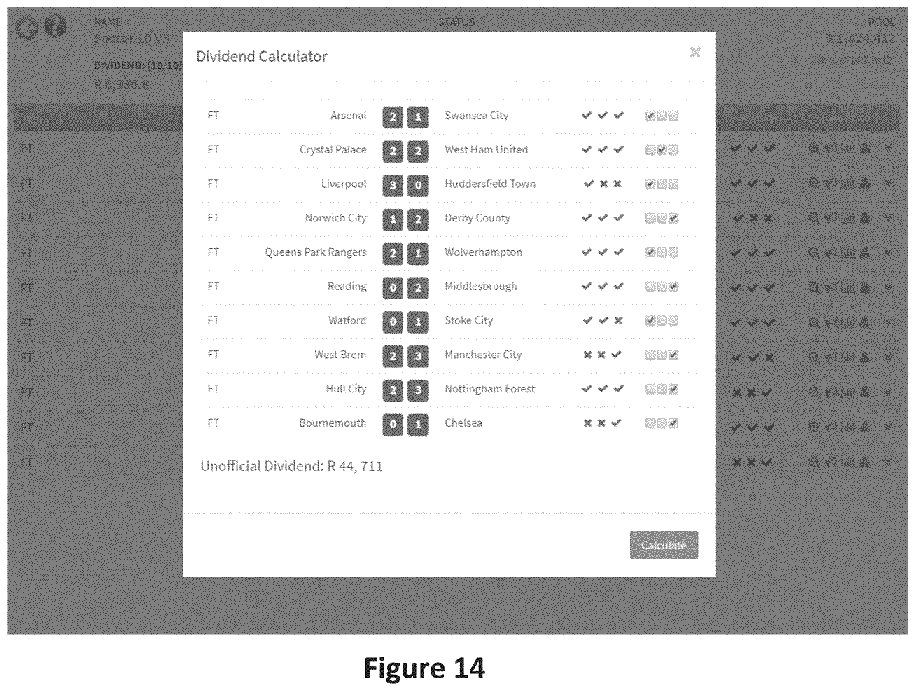

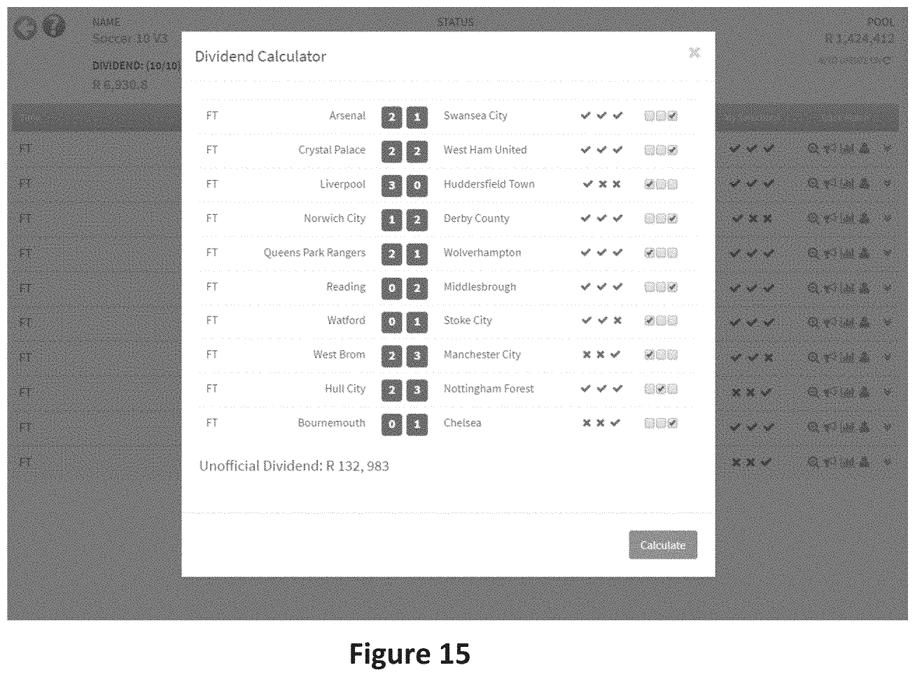

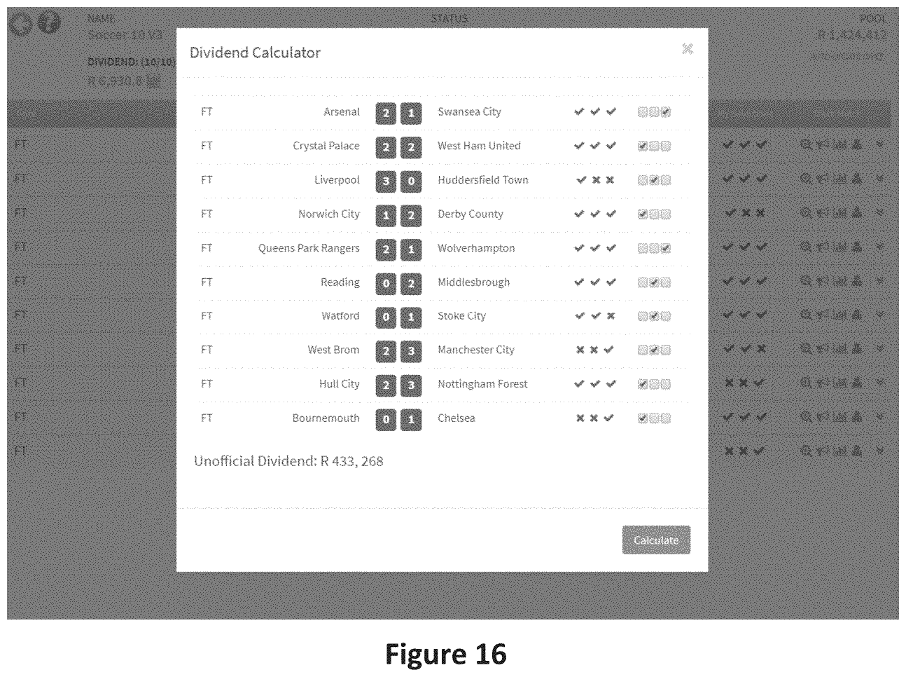

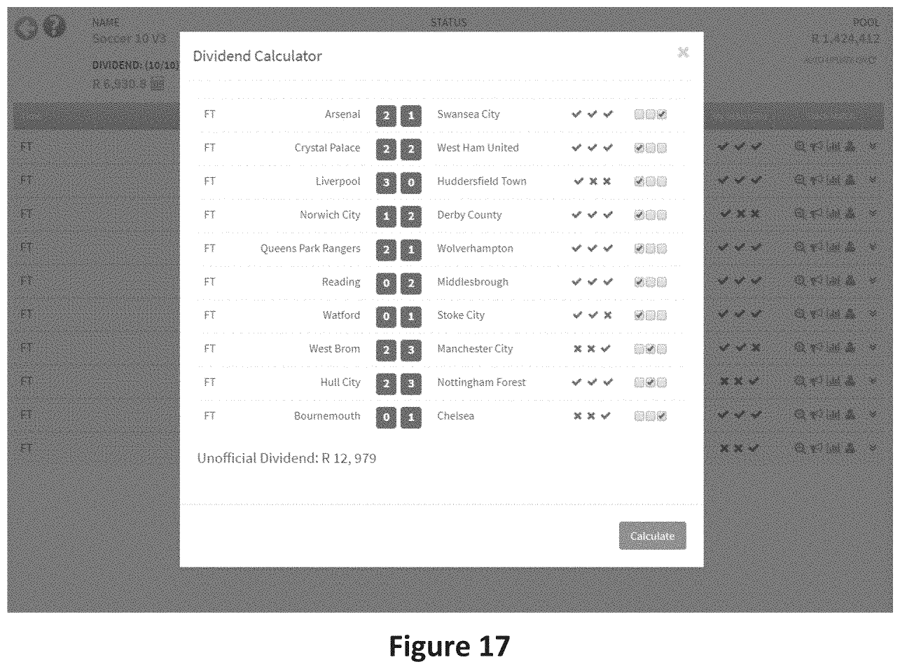

FIGS. 13-17 are screen shots of the dividend calculator depicting the selected pool of teams with a selection provided for each team to win or draw. The series of figures illustrates how the selection of teams and the resulting dividend projected is calculated in real-time. By way of illustration, FIG. 13 depicts a pool of teams selected to win or draw, the selection made rendering an unofficial dividend of 56,874; FIG. 14 the selection of Stoke City will change the unofficial dividend to 44,711; FIG. 15 the changes to the selection of West Brom v. Manchester City and Hull City v. Nottingham Forest will dramatically change the unofficial dividend to 132,983; FIG. 16 receives further changes from the user providing a resulting dividend of 433,268; FIG. 17 illustrates very conservative changes wherein the resulting unofficial dividend totals a dismal 12,979.

The dividend calculator enhancing the game by providing real time information to the user for not only selecting teams with information but comparing how that information is utilized by others in the pool as reflected by the dividend, the calculator providing a form of artificial intelligence prediction.

The information and dividend calculator improve and advances existing pool betting technologies providing a superior user experience at the time of bet placement and while tracking the status of the users bet. By providing the odds on potential results, league standings or any other information considered useful to a user to make an informed bet all integrated in same bet placement screen so the user need not look elsewhere. This would be specific to a sport type, such as football. In the case of tennis, the rankings and head to heads would be provided.

Once a user has placed a bet, the user can track the bet in real-time showing which selections are currently correct or incorrect. In real-time the application provides user stats, lineups, commentaries and scores about each game. This allows the user to quickly identify which fixtures are currently chosen correctly as well as providing some context around the fixture situation. Further, real-time updated payout ticket information relating to the user's combination is provided. The dividend calculator allows users to select ANY plausible combination of results and instantly understand what the potential payout would be if the selected results materialize.

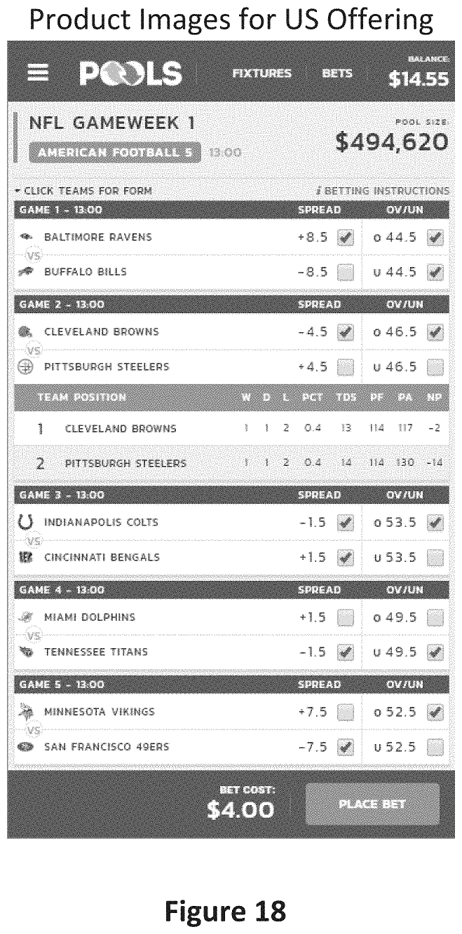

FIG. 18 is a diagram illustrating bet placement on a selection of NFL fixtures. In this illustration the punter needs to select the winner of the handicap as well as the over/under on the total points scored.

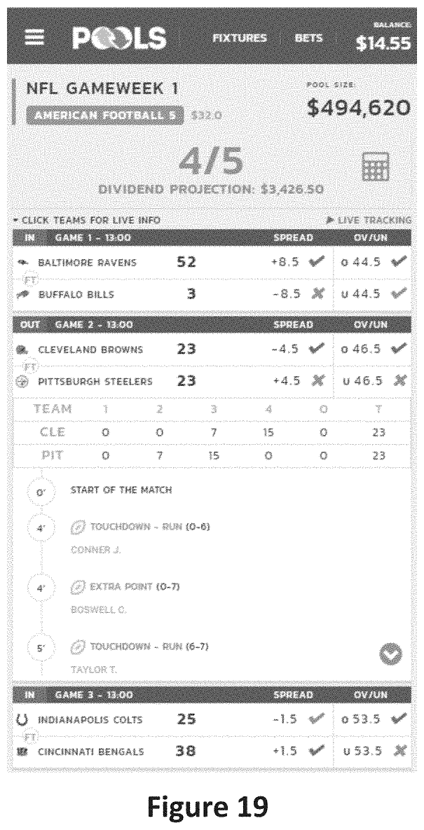

FIG. 19 is a diagram illustrating the bet tracking, which results are correct and which are incorrect in real time. The diagram also includes the dividend projection and the dividend calculator icon to pull up the dividend calculator.

The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps, possesses those one or more steps, but is not limited to possessing only those one or more steps.

It is to be understood that while a certain form of the invention is illustrated, it is not to be limited to the specific steps or arrangement herein described and shown. It will be apparent to those skilled in the art that various changes may be made without departing from the scope of the invention, and the invention is not to be considered limited to what is shown and described in the specification and any figures included herein. One skilled in the art will readily appreciate that the present invention is well adapted to carry out the objectives and obtain the ends and advantages mentioned, as well as those inherent therein by a number of steps. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims.

What is claimed is:

1. A computer-implemented dividend calculator to facilitate bet tracking by an artificially intelligent decision tree analysis, by way of a computer processor on a server that is in network communication with a user terminal comprising the steps of:
selecting a pool to bet on from a predefined database stored on the server by a user terminal;
placing a bet on the selected pool by use of the user terminal and forwarding said bet to the server for validation;
validating said bet by use of the server and acknowledging validation to the user terminal;
displaying information regarding the pool on the user terminal;
employing a dividend calculator wherein the user can enter any plausible combination from the pool to obtain a decision tree based, real-time dividend result;
displaying the real-time dividend result of said dividend calculator on the user terminal;
adjusting said bet based upon the real-time result;
allowing the pool to conclude;
paying of dividends to the user.

2. The decision tree based dividend calculator according to claim 1 including the step of receiving real-time updates of dividend changes from said dividend calculator.

3. The decision tree based dividend calculator according to claim 1 including the step of tracking the progress of a sports pool bet.

4. The decision tree based dividend calculator according to claim 1 including the step of allowing a user to poll potential payouts based on a potential score change.

5. The decision tree based dividend calculator according to claim 1 including the step of providing stats, lineups, commentaries and scores about each game in real-time integrated in the users bet.

6. The decision tree based dividend calculator according to claim 1 including the step of providing real-time updated payout ticket information relating to the users winning ticket and the current results potentially pay using decision tree analysis of ticket information.

7. The decision tree based dividend calculator according to claim 1 including the step of polling the dividend calculator to calculate decision tree potential dividends based on incomplete events.
